(19) United States
(12) Patent Application Publication
(10) Pub. No.: US 2023/0133360 A1
(43) Pub. Date: May 4, 2023

(54) Compute-In-Memory-Based Floating-Point Processor

(71) Applicant: Taiwan Semiconductor Manufacturing Company, Ltd., Hsinchu (TW)

(72) Inventors: Rawan Naous, Hsinchu (TW); Kerem Akarvardar, Hsinchu (TW); Mahmut Sinangil, Campbell, CA (US); Yu-Der Chih, Hsinchu (TW); Saman Adham, Kanata (CA); Nail Etkin Can Akkaya, Hsinchu (TW); Hidehiro Fujiwara, Hsinchu (TW); Yih Wang, Hsinchu (TW); Jonathan Tsung-Yung Chang, Hsinchu (TW)

(21) Appl. No.: 17/825,036

(22) Filed: May 26, 2022

Related U.S. Application Data
(60) Provisional application No. 63/272,850, filed on Oct. 28, 2021.

(51) Int. Cl. G06F 9/30; G06F 9/355

(52) U.S. Cl. CPC G06F 9/3001; G06F 9/30036; G06F 9/3555

(57) ABSTRACT

Systems and methods for floating-point processors and methods for operating floating-point processors are provided. A floating-point processor includes a quantizer, a compute-in-memory device, and a decoder. The floating-processor is configured to receive an input array in which the values of the input array are represented in floating-point format. The floating-point processor may be configured to convert the floating-point numbers into integer format so that multiply-accumulate operations can be performed on the numbers. The multiply-accumulate operations generate partial sums, which are in integer format. The partial sums can be accumulated until a full sum is achieved, wherein the full sum can then be converted to floating-point format.

### CROSS-REFERENCE TO RELATED APPLICATIONS

This application claims priority to U.S. Provisional Application No. 63/272,850, filed Oct. 28, 2021, entitled “CIM-based Floating Point Processor” which is incorporated herein by reference in its entirety.

### TECHNICAL FIELD

The technology described in this disclosure generally relates to floating-point processors.

### BACKGROUND

Floating-point processors are often utilized in computer systems or neural networks. Floating-point processors are used to perform calculations on floating-point numbers and may be configured to convert floating-point numbers to integer numbers, and vice versa.

### BRIEF DESCRIPTION OF THE DRAWINGS

FIG. 1 is a block diagram of a floating-point processor, in accordance with some embodiments.

FIG. 2 is a block diagram of a quantization process of the present disclosure, in accordance with some embodiments.

FIG. 3 shows an example of a folding operation that may be implemented by a compute-in-memory device, in accordance with some embodiments.

FIG. 4 shows a data flow associated with an operation on numbers, in accordance with some embodiments.

FIG. 5 depicts a binary representation of a floating-point number, as well as a quantized output of that floating-point number, in accordance with some embodiments.

FIG. 6 depicts a shifted integer representation of an input value, in accordance with some embodiments.

FIG. 7 is a block diagram of a hardware implementation of the floating-point processor of the present disclosure, in accordance with some embodiments.

FIG. 8 is a block diagram of a quantizer, in accordance with some embodiments.

FIG. 9 is a block diagram of a decoder, in accordance with some embodiments.

FIG. 10 is a flow diagram showing the process of a floating-point processor performing a computation, in accordance with some embodiments.

FIG. 11 is a flow diagram of an operation of a floating-point processor in which a memory is implemented, in accordance with embodiments.

FIG. 12 shows a flow diagram of the computation process of the floating-point processor of the present disclosure, in accordance with some embodiments.

FIG. 13 is a table showing how varying parameters associated with the computation process may affect the operation of the floating-point processor, in accordance with some embodiments.

FIG. 14 is a flow diagram showing a computer-implemented process involving receiving partial sums and thereafter generating a number in floating-point format.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in some various examples. This repetition is for the purpose of simplicity and clarity and does not in itself dictate a relationship between some various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Some embodiments of the disclosure are described. Additional operations can be provided before, during, and/or after the stages described in these embodiments. Some of the stages that are described can be replaced or eliminated for different embodiments. Additional features can be added to the circuit. Some of the features described below can be replaced or eliminated for different embodiments. Although some embodiments are discussed with operations performed in a particular order, these operations may be performed in another logical order.

Floating-point processors are designed to perform operations on floating point numbers. Such floating-point processors may be implemented in many different environments. For example, floating-point processors of the present disclosure may be implemented in neural networks, as understood by one of ordinary skill in the art. These operations include multiplication, division, addition, subtraction, and other mathematical operations. In some implementations of the present disclosure, floating point processors include a quantizer, a compute-in-memory device, and a decoder. In conventional approaches, partial sums are accumulated, and a decoder converts the individual partial sums to floating point format. Individual partial sums output by a decoder must be accumulated in floating-point format to generate a full sum and perform subsequent calculations, which can be hardware intensive. For example, if partial sums are accumulated in floating-point format, addition would require having a normalization step for the exponent so that all values have the same exponent. Then, accumulation of the mantissa would be performed, with carry outs being reflected on the final exponent value.

The approaches of the instant disclosure provide floating-point processors that eliminate or mitigate the problems associated with conventional approaches. In some embodiments, the floating-point processors achieve these advantages by providing an accumulator which enables partial sums to be accumulated in integer format until a full sum is achieved. Thus the conversion from integer to floating-point format occurs only once, after the full sum is achieved. This is in contrast to the conventional approach in which multiple integers are converted to floating-point format multiple times, e.g., for each of the partial sums. In some embodiments, this accumulator is located within a decoder. This approach can eliminate or mitigate the need for complex hardware that is associated with generating partial sums in floating-point format with no accumulator support.

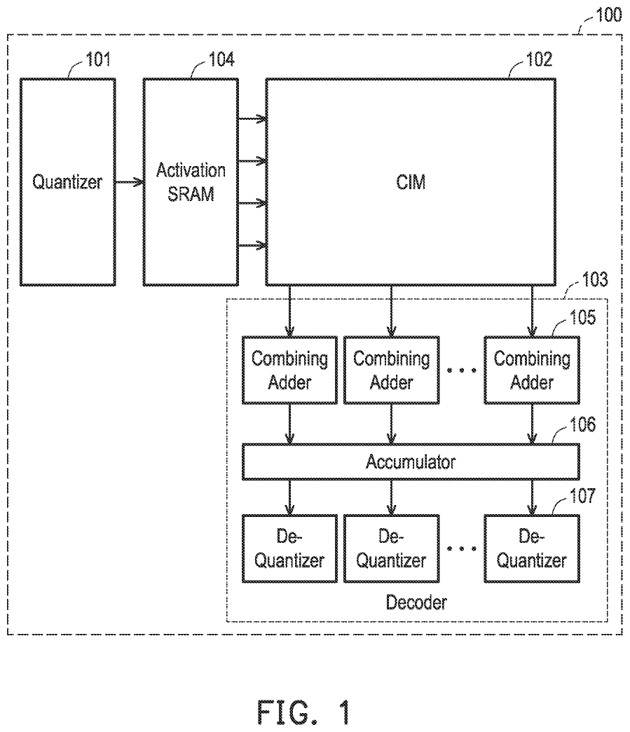

FIG. 1 is a block diagram of a floating-point processor 100, in accordance with some embodiments. As depicted in this FIG. 1, the floating-point processor 100 includes a quantizer 101, a memory 104, a compute-in-memory device 102, combining adders 105, accumulators 106, and dequantizers 107. The quantizer 101 receives numbers in floating-point format and converts those numbers into integer format. The memory 104 is coupled to the quantizer 101 and receives the integer numbers from the quantizer 101. The memory 104 is a static random access memory (SRAM) in some embodiments. The memory 104 allows these quantized inputs to be temporarily stored while a scaling factor representing a maximum value of all values of an input array is determined. This scaling factor representing a maximum value of all received inputs eliminates the need for the integer numbers to be quantized multiple times, in accordance with some embodiments. The memory 104 may be coupled to the compute-in-memory device 102 and may generate integer numbers that are in turn received by the compute-in-memory device 102. The compute-in-memory device 102 is a device including a memory cell array coupled to one or more computation/multiplication blocks and is configured to perform vector multiplication on a set of inputs, in some embodiments. In some example compute-in-memory devices, the memory cell device is a magneto-resistive random-access memory (MRAM) or a dynamic random-access memory (DRAM). Other memory cell devices may be implemented that are within the scope of the present disclosure. In one example, the compute-in-memory device 102 performs mathematical operations on the received integer numbers. The compute-in-memory device 102 performs multiply-accumulate operations on the integer numbers in some embodiments. Partial sums may be produced from the multiply-accumulate operations, as understood by one of ordinary skill in the art.

In some embodiments of the present disclosure, the partial sums are received by combining adders 105. A combining adder 105 is a set of adders that receives the partial sums over multiple channels (e.g., 4-bit partial sums) and time steps to generate the full partial sums (e.g., 8-bit partial sums) from the output of the compute-in-memory device 102. The combining adders 105 are coupled to dequantizers 107 in embodiments, and the dequantizer 107 may be configured to receive the partial sums in integer format. The dequantizers 107 include accumulators 106 in some embodiments. In embodiments of the present disclosure, the dequantizer 107 is configured to receive the partial sums, to accumulate the partial sums in integer format in the accumulator 106 serially until a full sum is achieved, and then to convert the full sum from integer to floating-point format. In this way, the floating-point processor 100 performs accumulation of the partial sums in integer format. This enables the implementation of simpler hardware requirements, as compared with the hardware requirements involved with accumulation in floating-point format.

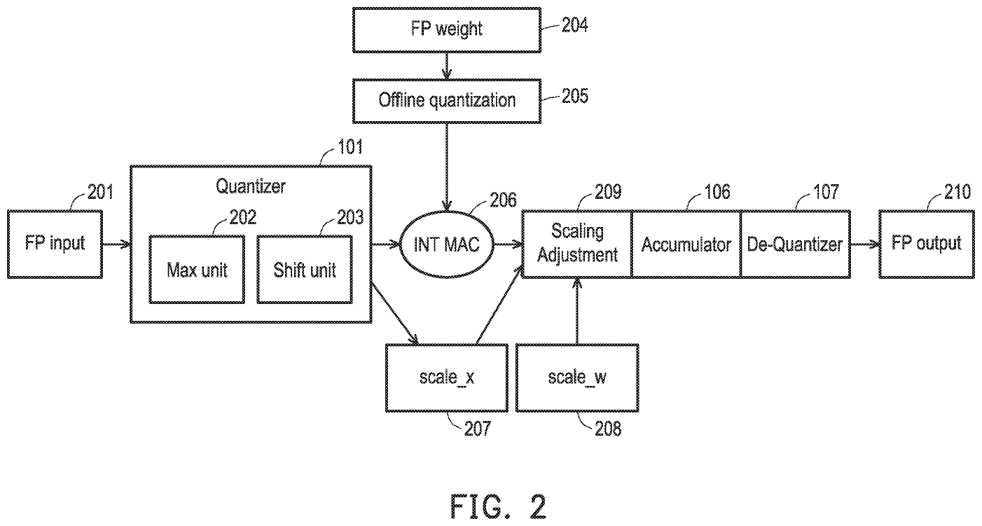

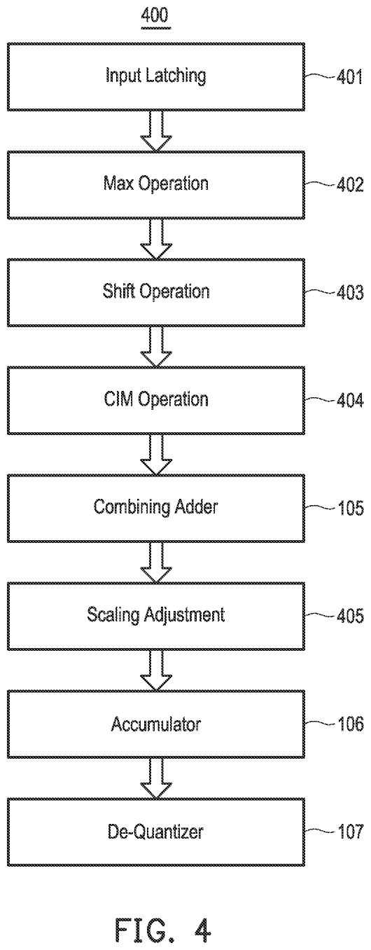

FIG. 2 is a block diagram of a quantization process of the present disclosure, in accordance with some embodiments. In the process of FIG. 2, the quantizer 101 receives a single input vector 201 of a predetermined number of values. These values are in floating-point format. The quantizer 101 is configured to find the maximum value of this predetermined number of values, and to set the scaling factor scale_x 207 to reflect that maximum value, in accordance with some embodiments. In the example of FIG. 2, the quantizer 101 also contains a max unit block 202 and shift unit block 203, as described further with respect to FIGS. 4 and 6. As discussed further below, the max unit block 202 is used to determine the maximum exponent value of the input vector 201. As is also described further below, the shift unit block 203 is used to perform the shift operations on the input vector 201 after the scaling factor is set. The scaling factor scale_x 207 is used to convert floating-point values to integer values. The quantizer 101 then quantizes each element of the input vector 201, generating integer numbers, and the scaling factor scale_x 207 is utilized in a scaling adjustment process 209. The integer numbers generated by the quantizer 101 undergo operations within the compute-in-memory device 102, in embodiments. For example, the integer values undergo multiply-accumulate operations, in some embodiments. As a result of these multiply-accumulate operations, partial sums are generated, as understood by one of ordinary skill in the art.

Thereafter, the scaling adjustment operation 209 may be performed on the partial sums. The scaling adjustment operation 209 may be accomplished, for example, through the use of scaling factors such as scale_x 207 and scale_w 208. In the example of FIG. 2, scaling factor scale_x 207 is dynamically generated through the quantizer. scale_x 207 is the scaling factor that is applied to the input vector to perform the quantization of floating-point representation to integer representation. The conversion is performed by dividing the floating-point number by scale_x 207. Scaling factor scale_w 208 may be a scaling factor associated with the weights applied to the input values by the compute-in-memory device 102, and may be loaded into the system through a register. In some embodiments, the weight vector corresponds to values of one or more trained filter coefficients within a particular layer of a neural network. Following the scaling adjustment 209 of the partial sums, the partial sums are received by an accumulator 106, in embodiments. In the example shown in FIG. 2, the partial sums are represented in integer format when they are received at the accumulator 106. The partial sums are received serially until a full sum is generated. When a full sum is achieved at the accumulator 106 in integer format, the full sum is received at the dequantizer 107, where the full sum is converted to floating-point format, in accordance with some embodiments.

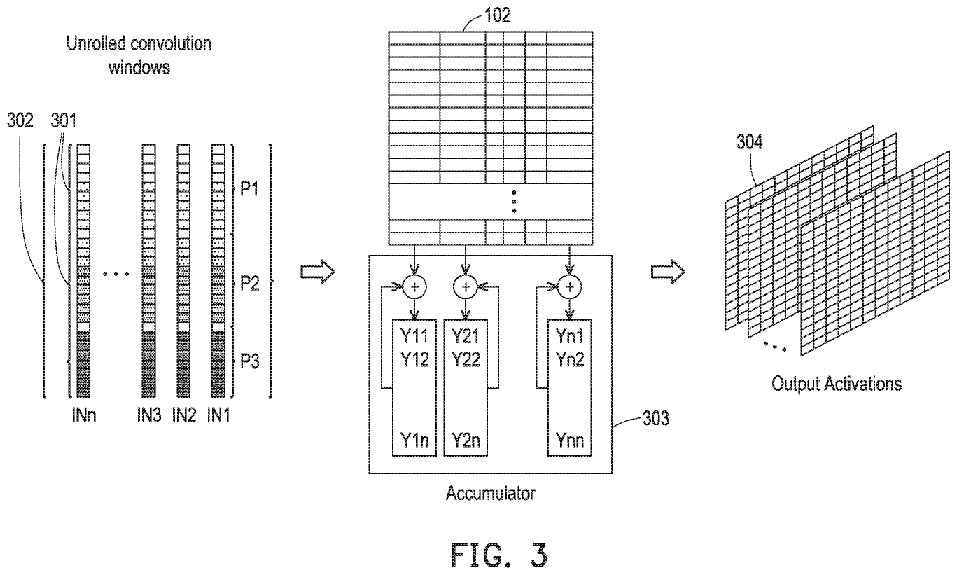

FIG. 3 shows an example of a folding operation that may be implemented by the compute-in-memory device 102, in accordance with some embodiments. In embodiments, the quantizer 101 generates input arrays 302 containing integer values. The compute-in-memory device 102 is configured to perform multiply-accumulate operations on these input arrays 302 through convolution operations, as understood by one of ordinary skill in the art. To successfully perform a multiply-accumulate operation on the input arrays 302, the number of elements in the vertical dimension of the compute-in-memory device 102 must be greater than or equal to the number of input elements received by the compute-in-memory device 102 at once. The number of input elements received by the compute-in-memory device 102 at once is equal to the number of elements in a single column of the input array 302. In embodiments of the present disclosure, when the number of elements in a single column of an input array 302 is greater than the number of elements in the vertical dimension of the compute-in-memory device 102, the compute-in-memory device 102 performs a folding operation on the input array 302. This ensures that the number of elements received by the compute-in-memory device 102 is limited to a number that is capable of undergoing a multiply-accumulate operation.

For example, the number of elements in the vertical dimension of the compute-in-memory device 102 may be 10. If the vertical dimension of an input array 302 is 25, then a folding operation allows the input array 302 to be divided into segments 301 such that a convolution operation is possible. In this example, where the vertical dimension of the input array 302 is 25 and the vertical dimension of the compute-in-memory device 102 is 10, the input array 302 may be divided into three separate folds 301. The folds may also be referred to as “segments.” The first and second fold 301 may be 10 elements each, while the third fold may be 5 elements. In this way, each fold 301 can be received at the compute-in-memory device 102 as an input, such that multiply-accumulate operations can be performed.

In the example of FIG. 3, accumulators 303 are shown at the output of each column of the compute-in-memory device 102. These accumulators 303 each receive a partial sum generated by the multiply-accumulate operations of the compute-in-memory device 102, as described above with reference to FIG. 2. In embodiments of the present disclosure, the partial sums generated by the compute-in-memory device 102 are referred to as temporal partial sums, because at the time they are generated by the compute-in-memory device 102, they have not appropriately shifted according to scaling factors such as scale_x 207 and scale_w 208. Following the generation of these temporal partial sums, the temporal partial sums are received by the decoder 103 and output activations 304 may then be generated, as discussed further below.

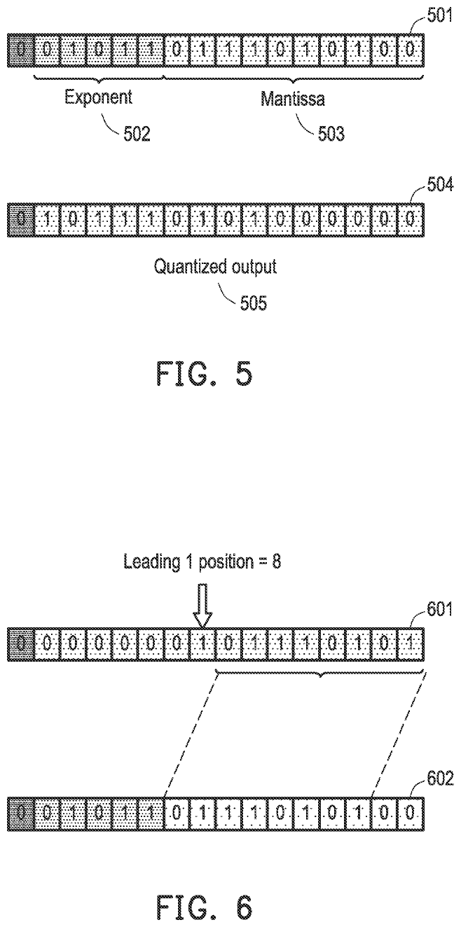

FIG. 4 shows the data flow associated with an operation on numbers 400, in accordance with some embodiments. This figure will be described in conjunction with FIGS. 5 and 6. In the example of FIG. 4, the quantizer 101 first receives a number in floating-point format. Input latching 401 may occur, as understood by one of ordinary skill in the art. Input latching 401 can occur in the compute-in-memory device 102 or in a separate random-access memory circuit (e.g., SRAM) prior to being received at the compute-in-memory device 102. The floating-point numbers may be received in binary representation 501, as shown in the embodiment of FIG. 5. The binary representation 501 of the floating point numbers may include an exponent 502 and a mantissa 503. In embodiments, the mantissa 503 is a portion of a number representing the significant digits of that number. The value of the number is obtained by multiplying the mantissa by the base raised to the exponent. For example, in a base 2 system (e.g., binary system), the value of a binary number may be obtained by multiplying the mantissa by 2 raised to the power of the exponent. Thereafter, a max operation 402 occurs in embodiments, which is an operation in which a maximum value of the exponents of the input array 302 is determined, as described above. During the max operation 402, the scale factor scale_x 207 is determined, in embodiments. Following the determination of the scaling factor scale_x 207, a shift operation 403 occurs in some embodiments. This operation is based on the particular value of the mantissa 503 and the exponent 502 and is used, for example, in the conversion of the floating-point number 501 to an integer number 504 (e.g., quantization).

In embodiments, the shift operation 403 is based on a shift unit 203 to generate the corresponding integer representation of a floating-point number. For floating-point numbers represented in a signed mode, a shift unit 203 is calculated according to equation 1, and is expressed as:

shift unit=num_bits−2−max_unit+exponent(i) (1)

where num_bits is the number of bits in the mantissa of the floating-point number, max unit is the maximum value of the exponents of the input array 302, and exponent(i) is the exponent of the floating-point number. For floating-point numbers represented in unsigned mode, the shift unit 203 is calculated according to equation 2, and is expressed as:

shift unit=num_bits−1−max_unit+exponent(i) (2)

After the shift operation 403 occurs, an integer number 504 is then received at the compute-in-memory device 102 as an input. In the compute-in-memory device operation 404, the compute-in-memory device 102 performs multiply-accumulate operations on the integer numbers 504. The multiply-accumulate operations produce partial sums, in embodiments, as discussed above. The partial sums are received by a combining adder 105 within the decoder 103, in embodiments, as shown in step 405. Then, a scaling adjustment 405 may be made based on the scaling factors scale_x 207 and scale_w 208. During scaling adjustment 405, the scaling factors of both integer operands (scale_x 207, scale_w 208) are used to adjust the output value of the multiply-accumulate operation.

After the scaling adjustment 405 is made, the adjusted integer partial sums are received at the accumulator 106, in embodiments. The partial sums are received serially until a full sum is achieved. Following the calculation of the full sum by the accumulator 106, the full sum is converted into floating-point format by the dequantizer 107. Aspects of this conversion are depicted in FIG. 6. In the example of FIG. 6, the shift unit 203 that was calculated was 2. Therefore, the conversion from integer to floating-point format involves a shifting of the digits following a leading 1 position within the integer representation 601 by two units to the left, as shown by the dashed lines of FIG. 6. In some embodiments of the present disclosure, the accumulator 106 is located within the dequantizer 107.

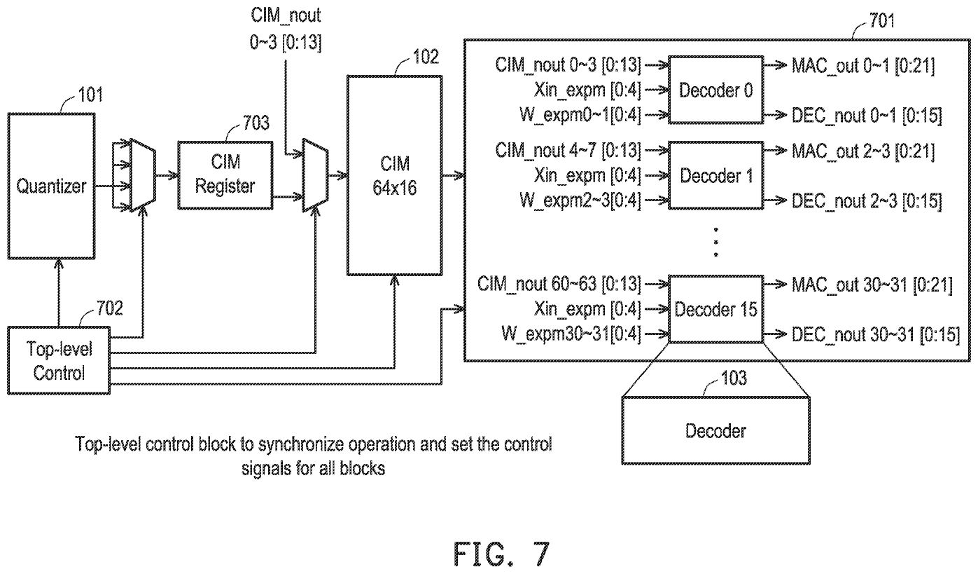

FIG. 7 is a block diagram of a hardware implementation of the floating-point processor 100 of the present disclosure, in accordance with some embodiments. In the example of FIG. 7, the floating-point processor 100 includes the quantizer 101, the compute-in-memory device 102, and the top-level decoder 701. Also shown in FIG. 7 is a compute-in-memory register 703 and a top level control block 702 is also shown in FIG. 7. The top level control block 702 is used to synchronize the operation of the floating point processor 100 and to send various control signals to the quantizer 101, the compute-in-memory device 102, and the decoders 103 based on the configuration of a given embodiment, as understood by one of ordinary skill in the art. As discussed earlier, the quantizer 101 is used to convert the floating-point numbers into integer format. The compute-in-memory register 703 provides data to the compute-in-memory device 102 when it is available. The top-level decoder 701 is composed of multiple single decoders 103. In some embodiments, the single decoders 103 can manage the output of four (4) channels. When each single decoder 103 is capable of managing the output of four (4) channels, and the compute-in-memory device 102 comprises sixty-four (64) channels, the top-level decoder 701 comprises 16 single decoders 103.

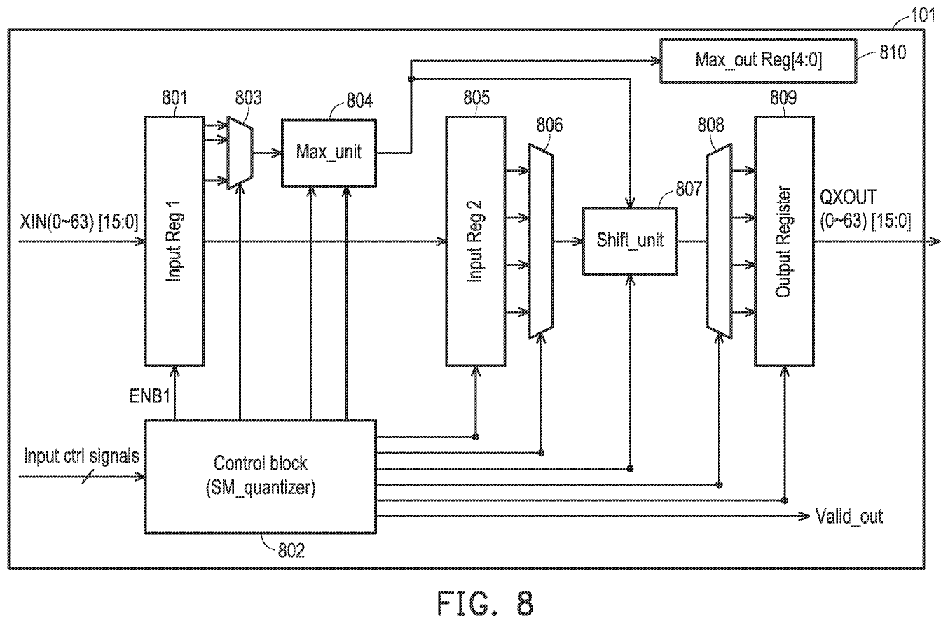

FIG. 8 is a block diagram of the quantizer 101, in accordance with some embodiments. In the example of FIG. 8, the quantizer 101 includes a first input register 801, a second input register 805, a control block 802, a max unit block 804, a shift unit block 807, a first multiplexer 803, a second multiplexer 806, a demultiplexer 808, an output register 809, and a max output register 810. In the example shown in FIG. 8, the quantizer 101 is configured to receive input arrays 302 at the first input register 801. The quantizer 101 functionality is based on finding the scaling factor and then applying the shifting operation 403 to convert a floating-point number to integer format. The max unit 804 is responsible for calculating the maximum exponent value from the input vector. Once the maximum exponent value is determined, it is saved in the max output register 810. The input registers (801, 805) are used to hold the input data to allow for the quantizer to finish the computation within the required number of cycles. The shift unit (807) is used to perform the shift operations on the input vector after the scaling factor is set. In some example embodiments, these operations are performed with 16 input values being input to the shift unit every cycle. Thus, the multiplexer 806 and demultiplexer 808 are used to set the corresponding values. The control block 802 generates the control signals needed for these operations according to the architecture of the given embodiment.

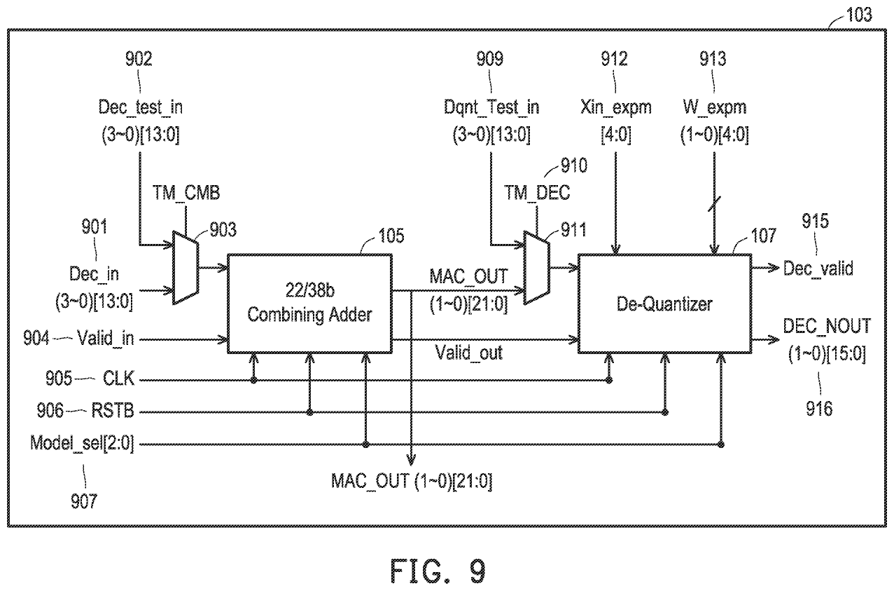

FIG. 9 is a block diagram of the decoder 103, in accordance with some embodiments. In the example of FIG. 9, the decoder 103 includes a first multiplexer 903, a second multiplexer 911, a combining adder 105, and a dequantizer 914. The dequantizer 914 may further include the accumulator 106. In embodiments of the present disclosure, the combining adder 105 is utilized to receive temporal partial sums from the compute-in-memory device 102, as understood by one skilled in the art. These temporal partial sums are then adjusted based on scaling factors scale_x 207 and scale_w 208 until a permanent partial sum is achieved. When the permanent partial sum is achieved, it then serves as an input to the dequantizer 107. In embodiments, the permanent partial sum is received by an accumulator (e.g., accumulator 106) of the dequantizer 107. This process continues for each temporal partial sum generated by the compute-in-memory device 102. Each permanent partial sum is received by the dequantizer 107 serially until a full sum is achieved. This full sum is in integer form in embodiments. The dequantizer 107 is configured to convert this full sum to floating-point format. Conversion to floating-point format after a full sum is achieved enables simpler hardware implementation as compared to conventional approaches that convert each partial sum from integer to floating-point format.

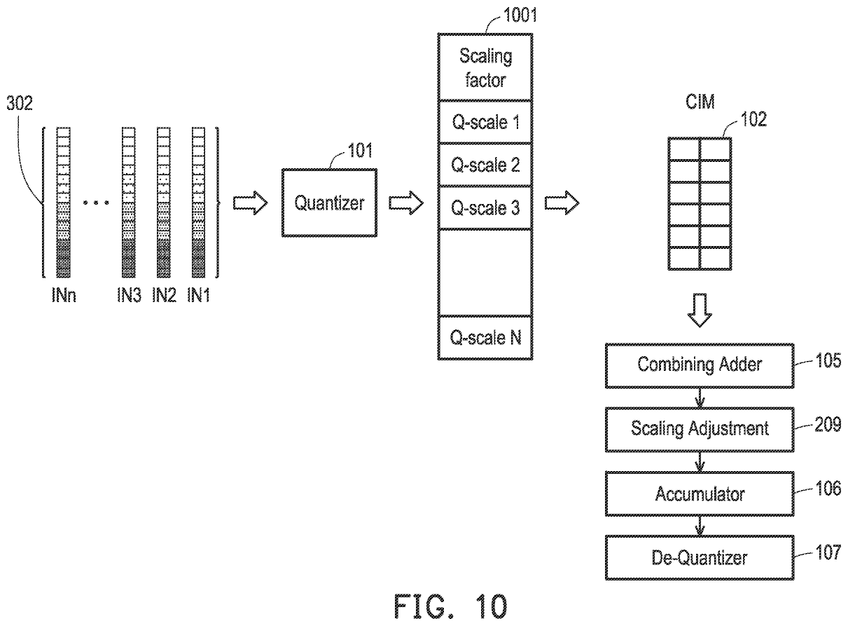

FIG. 10 is a flow diagram showing the process of a floating-point processor performing a computation, in accordance with some embodiments. As shown in FIG. 10, input vectors are received by the quantizer 101, and the quantizer 101 generates separate scaling factors 1001 for each input vector. For example, scaling factor Q-scale 1 may be a scaling factor associated with input vector IN1, Q-scale 2 may be a scaling factor associated with input vector IN2, and so forth. The quantizer 101 also converts each input vector 302 into integer format. These input vectors are received at the compute-in-memory device 102, where multiply-accumulate operations are performed to generate temporal partial sums. These temporal partial sums are received by the combining adder 105. Because the process of generating a permanent partial sum is temporal, the combining adder is utilized to save the partial sums and serially receive other partial sums thereafter to generate a final partial sum, as discussed further below.

Thereafter, the scaling adjustment operation 209 is performed on the temporal partial sums to generate a permanent partial sum. In embodiments, this process is performed serially. When a permanent partial sum is generated, the permanent partial sum is received by the accumulator 106. These permanent partial sums are received serially until a full sum is generated, in accordance with some embodiments. Once the full sum is generated, the dequantizer 107 converts the full sum from integer to floating-point format.

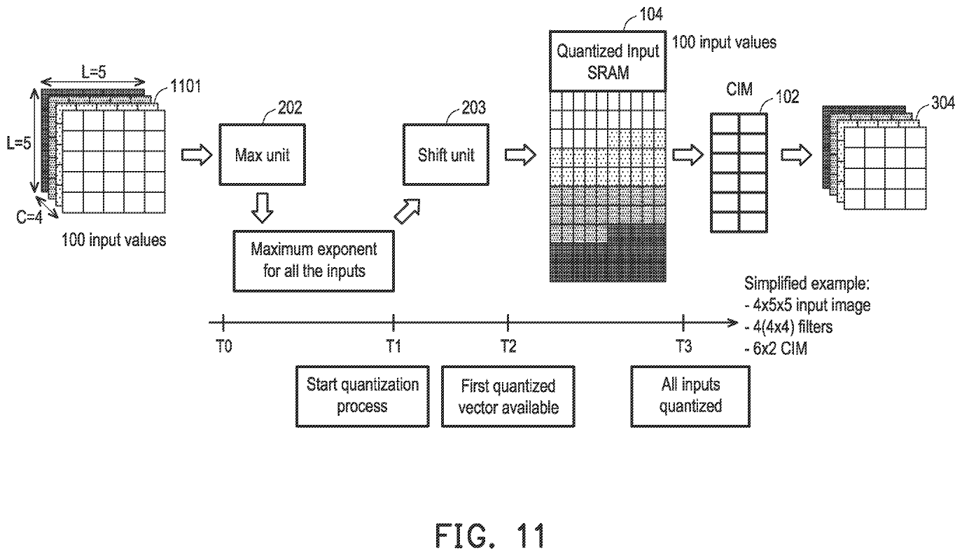

FIG. 11 is a flow diagram of an embodiment of the invention in which a memory (e.g., an activation SRAM) is used. In embodiments, the memory 104 is coupled to the quantizer 101 and the compute-in-memory device 102, as shown in FIG. 1. In the example of FIG. 11, the memory 104 receives an input array 1101 of 100 values. In embodiments, the quantizer 101 generates a single max unit 202 based on a maximum exponent value of all the 100 input values 1101. However, a separate shift unit 203 may need to be determined for each input value. This is because with a single max unit 202, which is representative of the maximum exponent of the input values, input values of different numeric values may need to shift by a different number of units when undergoing dequantization in order to be represented by the same exponent. In some example embodiments, the shift unit 203 has 16 internal shift entities that operate on 16 input values concurrently and the input vector is “pipelined” over four (4) cycles to perform the full shift operation.

Once the max unit 202 and shift unit 203 variables are determined, the quantized (e.g., integer) input values are received by the memory 104. Thereafter, the quantized input values may be received by the compute-in-memory device 102, and the compute-in-memory device 102 performs multiply-accumulate operations on the quantized values. These multiply-accumulate operations generate partial sums, in embodiments. However, with the inclusion of a quantization SRAM 104, each input vector need not undergo a scaling adjustment, as each input vector can share a common scaling factor scale_x 207.

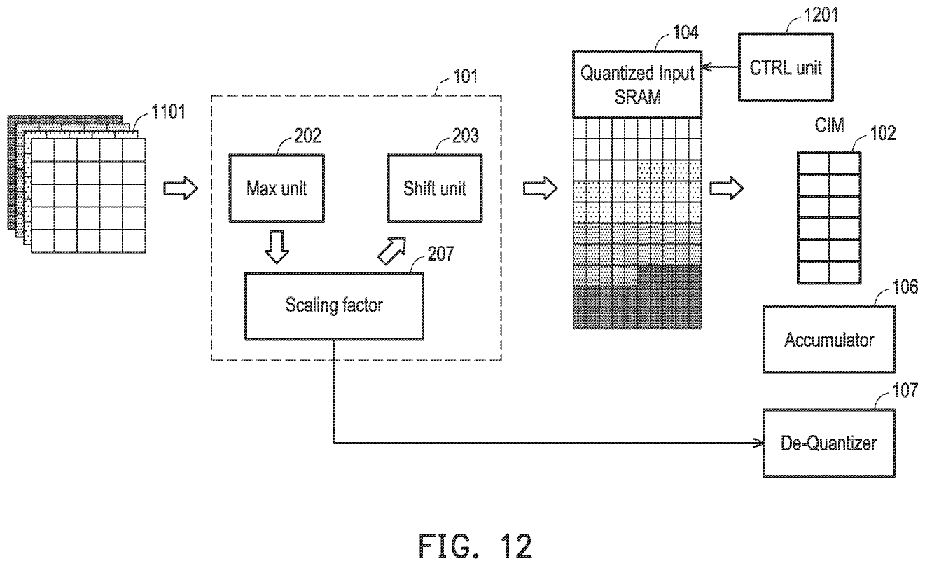

FIG. 12 shows a flow diagram of the computation process of the floating-point processor 100 of the present disclosure, in accordance with some embodiments. In the example of FIG. 12, the quantizer 101 receives input arrays 1101. For each received input array 1101, a scaling factor scale_x 207 is generated based on a maximum value 202 of the input array 1101. As demonstrated in FIG. 12, this scaling factor scale_x 207 is then passed to the decoder 107. This may be accomplished, for example, through the use of a register. A shift unit 203 is generated for each input value of the input array, and the shift unit 103 is stored in the memory 104. The shift unit 203 is used in the conversion of a floating-point number to an integer number, as explained in the discussion of FIGS. 4-6. Such a shift is illustrated by the dashed lines shown in FIG. 6. The floating-point processor 100 of FIG. 12 also includes a control unit 1201 that is used as an input to the memory 104. For example, the control unit 1201 may be responsible for loading the correct set of input vectors into the compute-in-memory device 102 for computation. These input vectors are integer based values that are generated from the quantizer. In embodiments, it is responsible for setting the read addresses in memory and for controlling synchronization of the computation, as understood by one skilled in the art. As discussed above, the compute-in-memory device 102 performs multiply-accumulate operations, which may generate partial sums. With the presence of the memory 104, the partial sums are received by the accumulator 106 without the need for scaling adjustment. This is because a scaling factor 207 common to all inputs is generated with the use of the memory 104, in embodiments, as discussed above. The accumulator 106 shown in FIG. 12 may receive each partial sum serially, updating a running sum with each subsequent partial sum received, until a full sum is generated. After a full sum is generated, the full sum is then received by the decoder 107, where it is converted from integer to floating-point format. As discussed above, this process eliminates the need for the more complex hardware requirements associated with accumulating partial sums in floating-point format.

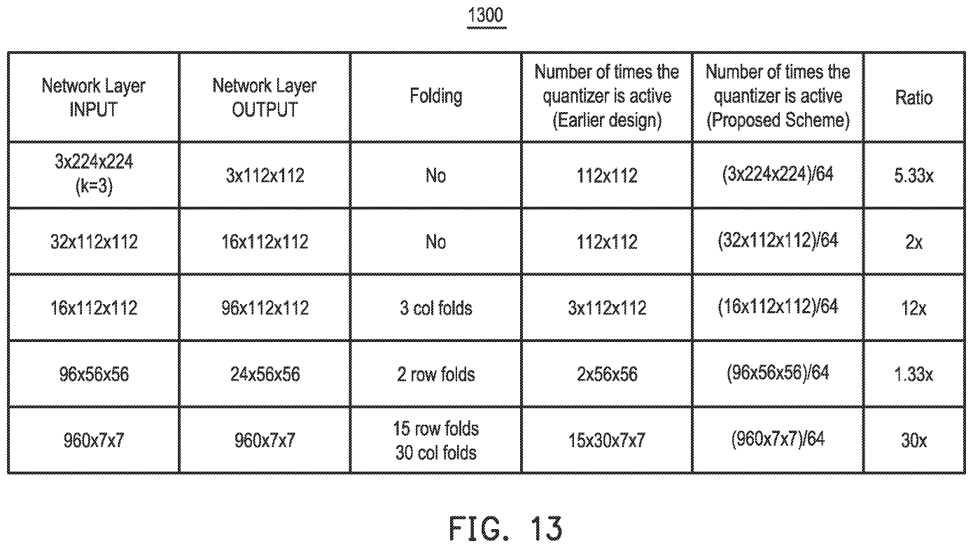

FIG. 13 is a table 1300 showing how varying different parameters associated with the computation process may affect the operation of the floating-point processor, in accordance with some embodiments. The folding operation shown in table 1300 is mainly determined by the size of the input, output, and the compute-in-memory device 102. In the example of table 1300, the compute-in-memory device 102 input size is 64×64, which represents 64 8-bit inputs and 32 8-bit channels. In the example shown by the first row of table 1300, the size of the input is determined by the first number (in the present example, 3) multiplied by the size of the kernel. In the example shown, k=3, so the kernel size is equal to the first number multiplied by k, which is 3×3, or 9. Thus, the size of the input is determined by multiplying 9 by 3, which is 27. Because 27 is less than 64, no folding operation is performed.

The column folding depicted in table 1300 is determined by the size of the output channels (in the present example, the network output layer). As shown in the first row of table 1300, the size of the output layer is equal to 32. This is equal to the number of channels available in the compute-in-memory device 102, so no column folding is performed either.

In the example shown by the third row of table 1300, the size of the input is 16. The kernel in this case is equal to 1×1, or 1. This is less than 64, so there is no row folding. However, the size of the output is 96. 96 is greater than 32, so column folding must be performed. The number of column folds required is 3, which is determined by dividing 96 by 32. The fourth row has an input size of 96 and an output size of 24. Thus, only 2 row folds are needed (determined by the ceiling of 96 divided by 64).

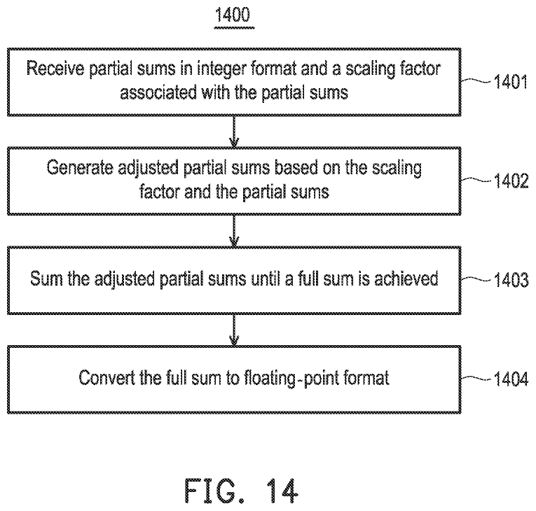

FIG. 14 is a flow diagram showing a computer-implemented process 1400. In the example shown in FIG. 14, partial sums, in addition to a scaling factor associated with the partial sums, may be received 1401. In some embodiments of the present disclosure, this could be accomplished by a combining adder. The next step 1402 in the process 1400 involves generating adjusted partial sums based on the scaling factor and the partial sums. The next step 1403 in the process 1400 is to sum the adjusted partial sums until a full sum is achieved. In one example, this process could be accomplished in an accumulator. In other embodiments of the present disclosure, this could be accomplished with other hardware components. The final step 1404 of the computer-implemented process 1400 is to convert the full sum to floating-point format. Each of the steps of process 1400 could be accomplished with a decoder and various hardware components with a decoder. The same process could also be accomplished with other hardware implementations, as understood by one skilled in the art.

The present disclosure is directed to a floating-point processor and computer-implemented processes. The present description discloses a system including a quantizer configured to convert floating-point numbers to integer numbers. The system also includes a compute-in-memory device configured to perform multiply-accumulate operations on the integer numbers and to generate partial sums based on the multiply-accumulate operations, wherein the partial sums are integers. Furthermore, the system of an embodiment of the present disclosure includes a decoder that is configured to receive the partial sums serially from the compute-in-memory device, to sum the partial sums in integer format until a full sum is achieved, and to convert the full sum from the integer format to floating-point format.

The system of the present disclosure further includes a static-random-access-memory (SRAM) device configured to receive the integer numbers and to generate a scaling factor based on the maximum value of the integer numbers, in accordance with some embodiments. The SRAM may be further configured to generate a shift unit, the shift unit being used in the conversion of floating point numbers to integer numbers.

The quantizer of the mentioned system may be further configured to generate an array of numerical values. In some embodiments, the compute-in-memory device comprises a plurality of receiving channels, and these receiving channels are configured to receive the array. Each receiving channel may comprise a plurality of rows. The number of rows may be equal to the number of integers the compute-in-memory device is capable of receiving. In some embodiments, the compute-in-memory device is further configured to divide the arrays into a plurality of segments. The number of integers contained in each segment may be less than or equal to the number of rows in the receiving channel.

In some embodiments, the compute-in-memory device further comprises a plurality of accumulators. The number of accumulators may be equal to the number of receiving channels. Each accumulator may be dedicated to a particular receiving channel, and each accumulator may be coupled to the receiving channel to which it is dedicated. Each accumulator can be configured to receive one of the partial sums.

The decoder may further comprise a dequantizer, wherein an accumulator is located within the dequantizer. The decoder may also include a combining adder. Such a combining adder can be configured to receive the partial sum and the scaling factor associated with the partial sum, and to adjust the partial sum based on the scaling factor, the adjustment occurring prior to the accumulator receiving the partial sum.

The present description also discloses a computer-implemented process. In some embodiments of the present disclosure, the process includes receiving partial sums in integer format and a scaling factor associated with the partial sums; generating adjusted partial sums based on the scaling factor and the partial sums; summing the adjusted partial sums until a full sum is achieved; and converting the full sum to floating-point format.

The present disclosure is also directed to a decoder configured to convert integer numbers to floating-point numbers. In some embodiments, the decoder includes a combining adder, an accumulator, and dequantizer. The combining adder may be configured to receive partial sums in integer format and to scale the partial sums to generate adjusted partial sums. The accumulator may be configured to receive the adjusted partial sums serially until a full sum in integer format is achieved. The dequantizer may be configured to receive the full sum in integer format and to convert the full sum to floating-point format.

In some example embodiments, the accumulator is located within the dequantizer. The combining adder may be further configured to receive scaling factors associated with the partial sums, the scaling of the partial sums being based on the scaling factors. In some example embodiments, the decoder is coupled to a compute-in-memory device that is configured to generate the partial sums in integer format.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system comprising:
a quantizer configured to convert floating-point numbers to integer numbers;
a compute-in-memory device configured to perform multiply-accumulate operations on the integer numbers and to generate partial sums based on the multiply-accumulate operations, the partial sums being integers; and
a decoder configured to
receive the partial sums serially from the compute-in-memory device,
sum the partial sums in integer format until a full sum is achieved, and
convert the full sum from the integer format to a floating-point format.

2. The system of claim 1, further comprising a static-random-access-memory device configured to receive the integer numbers and to generate a scaling factor based on the maximum value of the integer numbers.

3. The system of claim 2, wherein the static-random-access-memory device is further configured to generate a shift unit used in the conversion of floating-point numbers to integer numbers.

4. The system of claim 1, wherein the quantizer is further configured to generate an array of numerical values.

5. The system of claim 4, wherein the compute-in-memory device comprises a plurality of receiving channels.

6. The system of claim 5, wherein the receiving channels are configured to receive the array.

7. The system of claim 6, wherein each receiving channel comprises a plurality of rows, wherein the number of rows is equal to the number of integers the compute-in-memory device is capable of receiving.

8. The system of claim 7, wherein the compute-in-memory device is further configured to divide the arrays into a plurality of segments.

9. The system of claim 8, wherein the number of integers contained in each segment is less than or equal to the number of rows in the receiving channel.

10. The system of claim 9, wherein the compute-in-memory device further comprises a plurality of accumulators.

11. The system of claim 10, wherein the number of accumulators is equal to the number of receiving channels.

12. The system of claim 11, wherein each accumulator is dedicated to a particular receiving channel, wherein each accumulator is coupled to the receiving channel to which it is dedicated.

13. The system of claim 12, wherein each accumulator is configured to receive one of the partial sums.

14. The system of claim 13, wherein the decoder further comprises a dequantizer, wherein an accumulator is located within the dequantizer.

15. The system of claim 14, wherein the decoder further comprises a combining adder, the combining adder being configured to receive the partial sum and the scaling factor associated with the partial sum, and to adjust the partial sum based on the scaling factor, the adjustment occurring prior to the accumulator receiving the partial sum.

16. A computer-implemented process comprising:
receiving partial sums in integer format and a scaling factor associated with the partial sums;
generating adjusted partial sums based on the scaling factor and the partial sums;
summing the adjusted partial sums until a full sum is achieved; and
converting the full sum to floating-point format.

17. A decoder configured to convert integer numbers to floating-point numbers, the decoder comprising:
a combining adder configured to receive partial sums in integer format and to scale the partial sums to generate adjusted partial sums;
an accumulator configured to receive the adjusted partial sums serially until a full sum in integer format is achieved;
a dequantizer configured to receive the full sum in integer format and to convert the full sum to floating-point format.

18. The decoder of claim 17, wherein the accumulator is located within the dequantizer.

19. The decoder of claim 18, wherein the combining adder is further configured to receive scaling factors associated with the partial sums, the scaling of the partial sums being based on the scaling factors.

20. The decoder of claim 19, the decoder being coupled to a compute-in-memory device configured to generate the partial sums in integer format.
